(19) United States
(12) Patent Application Publication
(10) Pub. No.: US 2023/0257245 A1
(43) Pub. Date: Aug. 17, 2023

(54) Apparatus and method for manufacturing plastic containers with container rotation on transfer starwheels

(71) Applicant: KRONES AG, Neutraubling (DE)

(72) Inventor: Jochen HIRDINA, Regensburg (DE)

(21) Appl. No.: 18/108,932

(22) Filed: Feb. 13, 2023

(30) Foreign Application Priority Data
Feb. 11, 2022 (DE) 10 2022 103 317.1

(51) Int. Cl. B67C 3/24; B65G 47/86; B65G 47/24; B29C 49/42

(52) U.S. Cl. CPC B67C 3/242; B65G 47/847; B65G 47/24; B29C 49/42069; B29C 49/42075; B65G 2201/0244; B67C 2003/227

(57) ABSTRACT

Apparatus for producing plastic containers includes having a forming device for forming plastic preforms into plastic containers, a preform first transport device arranged downstream of the forming device and a second transport device for transporting formed containers from the forming device to a filling device, wherein the second transport device has a first transport unit and a second transport unit each having a movable carrier, on each of which a plurality of container gripping devices, wherein the gripping devices are each arranged pivotably with respect to the carriers such that a gripping device with a plastic container held by this gripping device can be pivoted with respect to a predetermined pivot angle.

### BACKGROUND OF THE INVENTION

The present invention relates to an apparatus and a method for manufacturing plastic containers. Such methods and apparatus have been known in the prior art for a long time. In this process, plastic preforms are first heated and then formed into plastic containers in forming devices such as, for example, blow moulding machines. These containers are then transported to a filling device where they are filled with a product, for example a beverage.

Forming devices are known which do not produce conventional containers with a circular cross-section, but with cross-sections deviating from this, for example oval or rectangular cross-sections.

In the case of arrangements of blow moulding machines and fillers, the problem with these moulded bottles, which have cross-sections deviating from circular, is that the removal angle from the blow mould does not always correspond to the required bottle position in the downstream unit, such as the filler. This is the case, for example, if the short side of a rectangular bottle is to be fed first in the filler unit.

In the prior art, this problem is solved by arranging an alignment module between the blow moulding machine and the filling device, in particular directly after the blow moulding machine, in which the blown containers are rotated through a defined angle to achieve the desired alignment in the filling device.

This alignment module is expensive and can usually only be retrofitted with great effort. The containers are rotated via stepper motors or via driven belts and the containers usually have to be attached to a mandrel for this purpose.

Especially for aseptic applications, this intervention in the orifice is not permitted. Therefore, there is still no alignment system for sterile applications in the internal state of the art. This leads to major problems with moulded bottles, as the angular alignment must be achieved via the mould parting line of the blow moulds. This in turn often leads to severe undercuts, which cause removal problems during demoulding and even destruction of the machines. High follow-up costs are the consequence of this (new moulds, special clamps, complaint costs, etc.).

Therefore, the invention has the object of providing an alignment system which can also be operated in an isolator, i.e. in a clean room, and which is preferably resistant to sterilising agents such as hydrogen peroxide. In addition, an alignment system is to be made available which is simpler than previously known solutions. Furthermore, a possibility should be created to be able to optimally position the mould parting line for aseptic moulds.

### SUMMARY OF THE INVENTION

An apparatus according to the invention for producing plastic containers and in particular beverage containers has a forming device which forms plastic preforms into plastic containers. The forming device has a first transport device which transports the plastic preforms during their forming, and a filling device which is arranged downstream of the forming device in the transport direction of the plastic containers and fills the plastic containers with a liquid.

The apparatus comprises a second transport device which transports the plastic containers from the forming device to the filling device, wherein the second transport device comprises at least a first transport unit and a second transport unit which transport the plastic containers and wherein these two transport units each comprise a movable carrier on which a plurality of gripping devices are arranged which are suitable and intended for gripping the plastic containers.

According to the invention, these gripping devices are each arranged so as to be pivotable relative to these carriers in such a way that a gripping device with a plastic container held by this gripping device can be pivoted through a predetermined pivot angle.

It is therefore proposed that the containers are rotated by two transport units, in particular without the need for a separate alignment module, so that the rotation takes place step by step. In this way, an alignment module that changes the rotational position of the manufactured plastic containers can be dispensed with.

As mentioned above, the plastic containers are in particular beverage containers. However, it would also be conceivable to fill the plastic containers with another substance, for example detergents or soaps.

Within the scope of the invention, it is therefore proposed that the plastic containers are not rotated in one step, but by way of several transport steps and in particular while they are held by said gripping devices and/or together with said gripping devices. It is thus proposed that the relatively large required rotational movement of the plastic containers (for example 451 is divided into several small rotational movem ents. This is relatively easy to do with blocks of blow moulding machine and filling devices, as there are always several transfer units which are arranged between the forming device, such as a blow moulding machine, and the filling device.

This division allows the necessary rotation of the containers to be divided from, for example, 30° to 2×15° or also from, for example, 45° to 3×15°.

These small angular displacements can be realised by rotating the gripping devices or clamps in the transfer starwheels. This means that the plastic containers remain fixed in the gripping devices (and in particular do not rotate relative to the respective gripping device) and the gripping device or clamp itself is rotated and/or pivoted by, for example, 15° from one transfer point to the next transfer point.

Preferably, a gripping device (in a standard version) is mounted on a movable fastening plate. This fastening plate is preferably moved through a fixed angle (e.g. with a stop position) in an activation zone or reset zone. It is possible that all transport units have the same displacement angle, but it would also be possible to have different displacement angles per starwheel.

Furthermore, it is possible that the invention can be solved via materials and mechanics already used in aseptics. In this way, a hygienic design is ensured (however, the same technique as for clamp starwheels can be used for opening and closing). It is also possible to retrofit the invention to existing equipment at an acceptable cost.

Preferably, a pivoting plane in which the gripping devices can be pivoted relative to their carriers is parallel to a transport plane of the plastic containers. Particularly preferably, this pivoting plane is perpendicular to a longitudinal direction of the plastic containers held by the gripping devices.

In a preferred embodiment, a geometric pivot axis, with respect to which the gripping device can be pivoted relative to the carrier, runs through a plane formed by the carrier.

Particularly preferably, the movable carrier of the transport unit is a carrier that can be rotated about a predetermined axis of rotation. Particularly preferably, the plastic containers are therefore moved along a substantially circular transport path. With this circularity, deviations resulting from the pivoting movement of the gripping device are neglected.

Particularly preferably, the transport units are transport wheels and/or transport stars. Preferably, these have a plurality of gripping devices arranged on the rotatable carrier. Preferably, these gripping devices are suitable and intended for gripping the plastic containers in the region of the mouth, in particular below the support ring of these plastic containers.

In a further advantageous embodiment, the second transport device comprises a third transport unit and this third transport unit in turn comprises a movable carrier on which a plurality of gripping devices are arranged which are suitable and intended for gripping the plastic containers.

In this embodiment, the plastic containers are transported in particular one after the other by the three transport units and are preferably transferred from a first of these transport units to a second of these transport units and preferably from the second of these transport units to the third of these transport units.

Furthermore, it is possible that said transport units not only transport the plastic containers, but that during the transport of the plastic containers with the transport units further treatment processes are carried out on the plastic containers, wherein preferably these are further treatment processes.

Along the transport path along which the plastic containers are transported, treatment units can be provided which are selected from a group of treatment units which includes sterilisation units for sterilising the plastic containers, inspection units for inspecting the plastic containers, labelling units for labelling the plastic containers, printing units for printing the plastic containers, cooling units for cooling sections of the plastic containers and the like.

Preferably, said transport units are arranged one behind the other along the transport path of the plastic containers. Particularly preferably, this third transport unit is also designed in such a way that the gripping device is arranged pivotable relative to said carrier in order to further increase the pivot angle in this way as well.

Particularly preferably, the predetermined pivot angle is greater than 5°, preferably greater than 10° and preferably greater than or equal to 15° In a further advantageous embodiment, the predetermined pivot angle is less than 80°, preferably less than 60°, preferably less than 40°, preferably less than 30° and particu larly preferably less than 20° .

The applicant has determined that angular ranges between 10° and 20° are, on the one hand, sufficiently large to achieve a sufficient pivot angle and that, on the other hand, they can still be managed in an advantageous manner without causing increased problems during the transfer or passing on of the plastic containers.

Particularly preferably, the predetermined pivot angle is adjustable. For example, it would be possible for a pivot angle of 15° to be set on a II transport units, but it would also be possible for this pivot angle to be reduced or increased as required. This adjustment can be made, for example, by setting stops that limit the pivot movement of the gripping device.

Particularly preferably, the pivoting of these gripping devices is mechanically limited, in particular by stops. Particularly preferably, the pivoting of the gripping devices relative to the carrier can be effected by a mechanical guide, for example by corresponding cams. This is explained in more detail below.

In this way, it is possible to achieve a defined and precise pivot position of the gripping devices with relatively simple means. However, it would also be possible for electric motor drives to be provided which effect said pivoting of the gripping device relative to the carrier.

In a further preferred embodiment, at least one transport unit has mechanical actuators that cause the gripping devices to pivot relative to their carrier.

Preferably, the forming device is suitable and intended for forming plastic containers having a main body with a cross-section deviating from a circular cross-section. Particularly preferably, this deviating cross-section is selected from a group of cross-sections comprising oval cross-sections, polygonal cross-sections and the like. However, the mouth area of the containers usually remains the same and still has a circular cross-section. The main body of the containers, which in particular holds the volume, has said deviating cross-section.

Particularly preferably, the forming device is a blow moulding machine and in particular a stretch blow moulding machine. This preferably also has a rotatable carrier on which a plurality of forming stations are arranged. These forming stations preferably each have blow moulds which can be opened and closed in order to form the plastic containers inside them.

In addition, these forming stations preferably have application devices which act upon the plastic preforms with a flowable and, in particular, gaseous medium in order to expand them. Particularly preferably, the forming device has a rod-shaped body that can be inserted into the plastic preforms, in particular a so-called stretching rod.

In a further advantageous embodiment, the apparatus has a clean room within which the plastic preforms and/or the plastic containers are transported at least in sections. Preferably, the forming process of the plastic preforms takes place within this clean room.

The present invention is particularly suitable in such applications, as mentioned above, because the transport devices can be designed in such a way that they do not have to grip the manufactured containers at and in particular in the mouths. Also, it is preferably not envisaged that plastic containers have to be rotated with respect to their holding devices or gripping devices, but rather, as mentioned above, they are rotated in particular with the gripping devices.

Particularly preferably, the clean room also extends over said second transport device. Particularly preferably, the filling device is also arranged in said clean room.

Particularly preferably, the further transport units of the second transport device are designed in such a way that they are at least partially resistant to sterilising agents such as H₂ O₂. In a preferred embodiment, the apparatus has overpressure generation means which keep the clean room under an overpressure (relative to the environment). Particularly preferably, the apparatus also has at least one hydraulic seal which seals off the clean room from an environment. For example, so-called water locks can be provided to seal the clean room from the environment.

Preferably, the gripping devices are gripping clamps which grip the plastic containers on their outer surface. This is particularly advantageous for sterile applications.

The present invention is further directed to a method for producing containers and, in particular, containers filled with a flowable medium. In this process, a forming device forms plastic preforms into plastic containers, wherein the forming device having a first transport device which transports the plastic preforms during their forming, and wherein a filling device being arranged downstream of the forming device in the transport direction of the plastic containers, which filling device fills the containers with a flowable medium and in particular a liquid.

Furthermore, a second transport device is provided which transports the containers from the forming device to the filling device, wherein the second transport device has at least a first transport unit and a second transport unit which transport the plastic containers and which transport them in particular one after the other. Furthermore, these two transport units each have a movable and in particular rotatable carrier, on which a plurality of gripping devices are arranged in each case, which grip the plastic containers.

According to the invention, these gripping devices are each arranged to be pivotable relative to these carriers in such a way that a gripping device with a plastic container held by this gripping device is pivoted by a predetermined pivot angle - in particular during transport.

In a preferred method, the plastic containers are rotated during transport with the second transport device. This rotation takes place in particular in steps and/or in sections. Thus, it is possible that the plastic containers are pivoted and/or rotated by the first transport unit by a predetermined pivot angle and then rotated and/or pivoted again by the second transport unit by a predetermined rotation or pivot angle.

The term pivoting or rotating the plastic containers refers to a rotation with respect to their own axis. The rotation caused by the movement on the transport unit is not taken into account. For example, if the plastic containers are transported by the transport unit through a circumferential angle of 300°, this also causes a r otation of the plastic containers about their own longitudinal axis by 300°. However, the p resent invention does not relate to this rotation, but to a rotation of the plastic containers with respect to the respective transport unit and/or with respect to the rotatable carrier of the transport unit.

In a preferred method, the gripping device with the plastic containers arranged thereon is pivoted through the predetermined angle relative to the carrier from a first pivot position into a second pivot position. Preferably, the gripping devices are then pivoted from the second pivot position into the first pivot position (back) without the plastic containers held thereon.

Preferably, the gripping devices are pivoted together with the plastic containers gripped by them. Preferably, the plastic containers are not rotated or pivoted with respect to the gripping devices gripping them.

### BRIEF DESCRIPTION OF THE DRAWINGS

Further advantages and embodiments can be seen in the attached drawings:

In the drawings:

FIG. 1 shows a schematic representation of an apparatus according to the invention;

FIG. 2 shows a representation of the second transport device with three transport units;

FIG. 3 shows a diagram illustrating the pivoting movement.

### DETAILED DESCRIPTION OF THE DRAWINGS

FIG. 1 shows a schematic representation of an apparatus 1 according to the invention. This has a heating device 12, such as an infrared oven, which heats plastic preforms 10. These plastic preforms are then transferred to the forming device 2 by means of a transport starwheel 32. This has a rotatable carrier 21 on which a plurality of forming stations 22 are arranged. After forming, the manufactured plastic containers 20 are transported to a filling device 6 by a second transport device 4. This second transport device 4 here has three transport units 42, 44 and 46, each of which is equipped with gripping devices 42a for gripping the plastic containers 20.

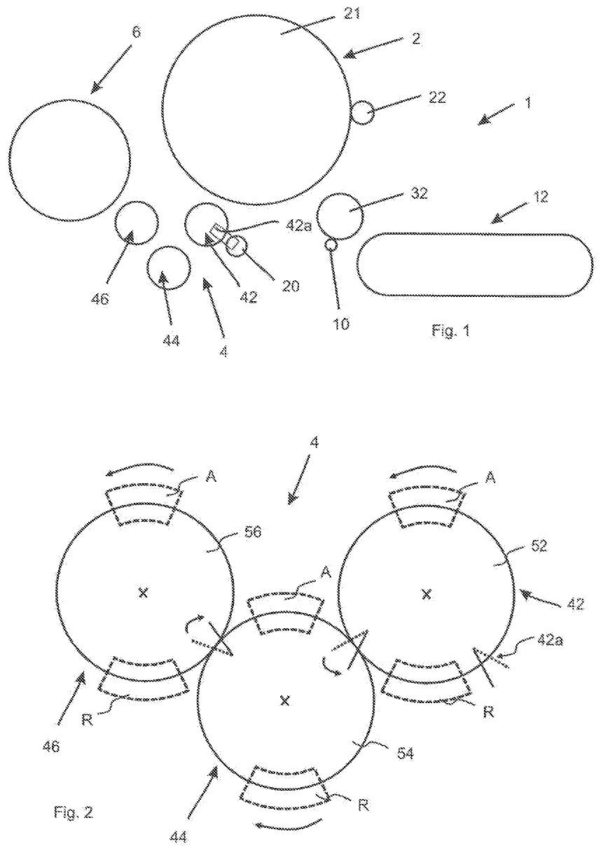

FIG. 2 shows a representation of the second transport unit 4 and the pivoting movement caused by it. Here you can again see the gripping device 42a (only shown schematically), which is part of the first transport unit 42 and which is arranged on a carrier 52. The containers gripped by the gripping device 42 are pivoted with the gripping devices in a pivot area A by a predetermined pivot angle, for example 15°.

The plastic containers are then transferred to the second transport unit 44. Finally, in a return area R, the gripping device is pivoted back into the starting position in which a further plastic container can be picked up.

Also by means of the transport unit 44, the plastic containers in the area A are again pivoted with the gripping devices by a predetermined pivot angle and then transferred to the third transport unit 46. Also during the transport by means of this transport unit 46, a pivoting of the gripping devices with the plastic containers held on them takes place in the area A, as well as a pivoting back of the now unoccupied gripping devices also in the area R.

In this way, the plastic containers as a whole are not only transported further by this transport, but also rotated by 3× a predetermined angle, for example 3×45°.

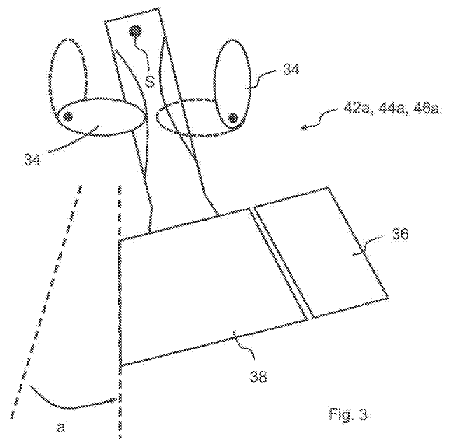

FIG. 3 shows a schematic representation of the apparatus according to the invention. Here again a carrier 38 is shown, on which a gripping element such as a gripping clamp (not shown) is arranged. This carrier 38 is pivotable by a predetermined pivot angle with respect to a pivot axis S. For this purpose, two adjusting cams 34 may be provided, each of which effects this pivoting movement. The reference sign 36 indicates a stop which limits the pivoting movement of the carrier 38 with respect to the pivoting axis S. It would be possible that by changing the position of the stop 36, the maximum pivot angle of the carrier 38 and thus of the gripping devices 42a, 44a, 46a is also changed.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. An apparatus for producing plastic containers, having a forming device which forms plastic preforms into plastic containers, wherein the forming device has a first transport device configured to transport the plastic preforms during their forming and with a filling device which is arranged downstream of the forming device in the transport direction of the plastic containers and configured to fill the plastic containers with a liquid, wherein the apparatus has a further second transport device configured to transport the containers from the forming device to the filling device, wherein the second transport device has at least a first transport unit and a second transport unit configured to transport the plastic containers, wherein these two transport units each having a movable carrier, on each of which a plurality of gripping devices are arranged, which are configured for gripping the plastic containers,
wherein
these gripping devices are each arranged pivotably with respect to these carriers in such a way that a gripping device with a plastic container held by this gripping device can be pivoted with respect to a predetermined pivot angle.

2. The apparatus according to claim 1,
wherein
a pivot plane in which the gripping devices are pivotable relative to the carriers is arranged parallel to a transport plane of the plastic containers.

3. The apparatus according to claim 1,
wherein
a movable carrier of at least one transport unit is a carrier rotatable about a predetermined axis of rotation.

4. The apparatus according to claim 1,
wherein
the second transport device comprises a third transport unit and said third transport unit comprises a movable carrier on which a plurality of gripping devices are arranged which are configured for gripping the plastic containers.

5. The apparatus according to claim 1,
wherein
the predetermined pivot angle is greater than 5° and/or the predetermined pivot angle is less than 80°.

6. The apparatus according to claim 1,
wherein
the forming device is configure to form plastic containers having a main body with a cross-section deviating from a circular cross-section.

7. The apparatus according to claim 1,
wherein
the apparatus has a clean room within which the plastic preforms and/or the plastic containers are transported at least in sections.

8. The apparatus according to claim 1,
wherein
the gripping device comprises gripping clamps configured to grip the containers at their outer surface.

9. A method for producing plastic containers, comprising providing an apparatus as claimed in claim 1, wherein a forming device forms plastic preforms into plastic containers, wherein the forming device has a first transport device which transports the plastic preforms during their forming and wherein a filling device arranged in the transport direction of the plastic containers downstream of the forming device fills the plastic containers with a liquid, wherein the apparatus has a further second transport device which transports the containers from the forming device to the filling device, wherein the second transport device has at least a first transport unit and a second transport unit which transport the plastic containers, wherein these two transport units each have a movable carrier, on each of which a plurality of gripping devices are arranged, which grip the plastic containers,
wherein
these gripping devices are each arranged pivotably with respect to these carriers in such a way that a gripping device with a plastic container held by this gripping device is pivoted with respect to a predetermined pivot angle.

10. The method according to claim 9,
wherein
the gripping device with the plastic containers arranged thereon are pivoted through the predetermined angle relative to the carrier from a first pivot position into a second pivot position and then the gripping devices without plastic containers held thereon are pivoted from the second pivot position into the first pivot position.

11. The apparatus according to claim 1,
wherein
the predetermined pivot angle is greater than 10° and/or the predetermined pivot angle is less than 60°.

12. The apparatus according to claim 1,
wherein
the predetermined pivot angle is greater than or equal to 15° and/or the predetermined pivot angle is less than 40°.

13. The apparatus according to claim 1,
wherein
the predetermined pivot angle is less than 30°.

14. The apparatus according to claim 1,
wherein
the predetermined pivot angle is less than 20°.
